(19) United States
(12) Patent Application Publication
(10) Pub. No.: US 2019/0128604 A1
(43) Pub. Date: May 2, 2019

(54) Recuperative Heat Exchange for Desiccation of Cold Fluids

(71) Applicants: Larry Baxter, Orem, UT (US); Aaron Sayre, Spanish Fork, UT (US); Kyler Stitt, Lindon, UT (US); Eric Mansfield, Spanish Fork, UT (US); Christopher Hoeger, Provo, UT (US); Andrew Baxter, Spanish Fork, UT (US); Nathan Davis, Bountiful, UT (US)

(72) Inventors: Larry Baxter, Orem, UT (US); Aaron Sayre, Spanish Fork, UT (US); Kyler Stitt, Lindon, UT (US); Eric Mansfield, Spanish Fork, UT (US); Christopher Hoeger, Provo, UT (US); Andrew Baxter, Spanish Fork, UT (US); Nathan Davis, Bountiful, UT (US)

(21) Appl. No.: 15/795,953

(22) Filed: Oct. 27, 2017

(51) Int. Cl. F25J 3/08; B01D 53/02; B01D 15/08

(52) U.S. Cl. CPC F25J 3/08; B01D 53/02; F25J 2205/50; F25J 2205/20; F25J 2205/60; B01D 15/08

(57) ABSTRACT

Devices, systems, and methods for removing a component from a fluid are disclosed. A feed fluid is heated by passing the feed fluid through a heating path of a first indirect-contact heat exchanger (ICHE). The feed fluid contains a first component. The fluid is heated from a first temperature to a second temperature, resulting in a heated feed fluid. The heated feed fluid is passed through a desiccator, containing a desiccant. The first component is bound up to the desiccant, resulting in a stripped-heated feed fluid. The stripped-heated feed fluid is cooled by passing the stripped-heated feed fluid through a cooling path of the first indirect-contact heat exchanger (ICHE). The stripped-heated feed fluid is cooled from a second temperature to a third temperature, the third temperature being greater than the first temperature, producing a product fluid.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to fluid separations. More particularly, the devices, systems, and methods described herein relate to desiccation and stripping components from fluids.

### BACKGROUND

Desiccation and stripping of compounds from fluids, gases or liquids, is often accomplished using solid desiccants and stripping agents. Solid desiccants, such as molecular sieves, and solid stripping agents, such as activated carbon, are useful but are required to be in certain temperature regimes to run optimally. Existing desiccants and stripping agents tend to be optimized for temperatures at or near ambient. Devices, methods, and systems capable of operating at a temperature higher than that of the process flow without significant heat losses would be beneficial.

### SUMMARY

Devices, systems, and methods for removing a component from a fluid are disclosed. A feed fluid is heated by passing the feed fluid through a heating path of a first indirect-contact heat exchanger (ICHE). The feed fluid contains a first component. The fluid is heated from a first temperature to a second temperature, resulting in a heated feed fluid. The heated feed fluid is passed through a desiccator, containing a desiccant. The first component is bound up to the desiccant, resulting in a stripped-heated feed fluid. The stripped-heated feed fluid is cooled by passing the stripped-heated feed fluid through a cooling path of the first indirect-contact heat exchanger (ICHE). The stripped-heated feed fluid is cooled from a second temperature to a third temperature, the third temperature being greater than the first temperature, producing a product fluid.

The second temperature may be maintained substantially at an ambient temperature. The feed fluid may be passed below a feed rate at which a first sensible heat transfer from the feed fluid to the desiccant is greater than a second sensible heat transfer from an ambient environment around the desiccator into the desiccant. The desiccator may have heat exchange surfaces mounted to the desiccator that increase the second sensible heat transfer from the ambient environment around the desiccator into the desiccant.

A difference between the first temperature and the third temperature may be between 0° C. and 20° C. The first temperature may be between −80° C. and −25° C.

The feed fluid may be a liquid. The liquid may consist of water, hydrocarbons, liquid ammonia, liquid carbon dioxide, cryogenic liquids, or a combination thereof. The first component may be carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts, precious metals, base metals, or a combination thereof.

The feed fluid may be a carrier gas. The carrier gas may consist of flue gas, syngas, producer gas, natural gas, steam reforming gas, hydrocarbons, light gases, refinery off-gases, organic solvents, steam, ammonia, or a combination thereof. The first component may be carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts or a combination thereof. A preliminary gas may be passed through a brine dryer, wherein a fraction of the preliminary gas consists of water and the brine dryer removes a portion of the water from the preliminary gas, producing the carrier gas. The product fluid may be cooled to a fourth temperature by passing the product fluid through a second ICHE, producing a cooled product fluid. The fourth temperature is below the first temperature. The cooled product fluid may be passed through a desublimating direct-contact heat exchanger, the desublimating direct-contact heat exchanger removing a second component from the product fluid.

The desiccant may be activated alumina, aerogel, benzophenone, Bentonite clay, calcium chloride, calcium oxide, calcium sulfate, cobalt(ii) chloride, copper(ii) sulfate, lithium chloride, lithium bromide, magnesium sulfate, magnesium perchlorate, molecular sieve, potassium carbonate, potassium hydroxide, silica gel, sodium chlorate, sodium chloride, sodium hydroxide, sodium sulfate, sucrose, activated carbon, biochar, ion-exchange resins, diatomaceous earth, porous membranes, xeolites, conjugated microporous polymers, porous ceramics, or a combination thereof.

### BRIEF DESCRIPTION OF THE DRAWINGS

In order that the advantages of the described devices, systems, and methods will be readily understood, a more particular description of the described devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIG. 1 shows an exemplary embodiment in which the described devices, systems, and methods may be implemented.

FIG. 2 shows a process for removing a component from a fluid.

FIG. 3 shows the process of FIG. 2 with the addition of a second ICHE.

FIG. 4 shows a system with a desiccator and an ICHE.

FIG. 5 shows an exemplary embodiment in which the described devices, systems, and methods may be implemented.

FIG. 6 shows a method for removing a component from a fluid.

### DETAILED DESCRIPTION

It will be readily understood that the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

The term desiccant, as used herein, is not limited to a hygroscopic substance that attracts and absorbs water. Rather, desiccation is defined herein as the removal of a component or components out of a fluid—gas, liquid, or slurry. The first component or components removed are not limited to water, but can include any substance being stripped, absorbed out of, removed from, or bound out of a fluid. A desiccant is, therefore, a solid that captures the first component or components out of the fluid. The term “stripped” is equivalent to the term “desiccated” herein. As such, desiccators can include traditional desiccators, strip vessels, filters, or any other system where solids are used to extract components.

Ambient temperature is vaguely and inconsistently defined in industry and literature. In general, this temperature is assumed to be 20 to 25° C. However, when used herein, ambient temperature is defined as a temperature between the freezing point of water and 60° C.

As cryogenic processes often require temperatures far below the freezing point of water, water is generally removed as early as possible in a cryogenic process, before it has a chance to freeze out in sensitive, low temperature equipment, potentially blocking or damaging that equipment. However, water is very difficult to remove. Processes like distillation require heat and are, therefore, heading the wrong direction. Brine drying (which operates at below ambient temperatures, for example) is an excellent solution, but incomplete (as it generally leaves a few parts per million of water in the process stream, for example). However, even a few parts per million of water can freeze up equipment at low cryogenic temperatures. As such, the devices, systems, and methods disclosed herein were developed to enable further drying of the process stream (using desiccation, for example). It is appreciated that the described devices, systems, and methods have much broader application than removing just water from the process stream. For example, the described devices, systems, and methods may be used to remove any of a variety of components (e.g., water, mercury, acid gases, and hydrocarbons) which are referred to generally as a component. It is further appreciated that the described devices, systems, and methods have broader application than cryogenics, including electrowinning, reverse-Arrhenius reactions involving solids, or any situation where a process needs to be warmed up for a single unit operation but then be cooled again after.

In short, the concepts herein involve pre-heating a process stream (i.e., using a stripped process stream from a desiccator) before it passes through the desiccator to remove a component from the process stream, binding that component to the solids in the desiccator (resulting in the stripped process stream, for example). The stripped process stream is then used to preheat the process stream. In the case of cryogenics, the source of heat can be as simple as the ambient environment. In other cases, some amount of heat would be added to the desiccator. In all instances, the amount of heat needed in the desiccator is reduced by the recuperative heat exchange step. In the case of cryogenics, the sensible heat requirements to reheat a desiccator are far less than the sensible heat requirements to preheat a process gas, making this solution critical for success.

Combustion flue gas consists of the exhaust gas from a fireplace, oven, furnace, boiler, steam generator, or other combustor. The combustion fuel sources include coal, hydrocarbons, and bio-mass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

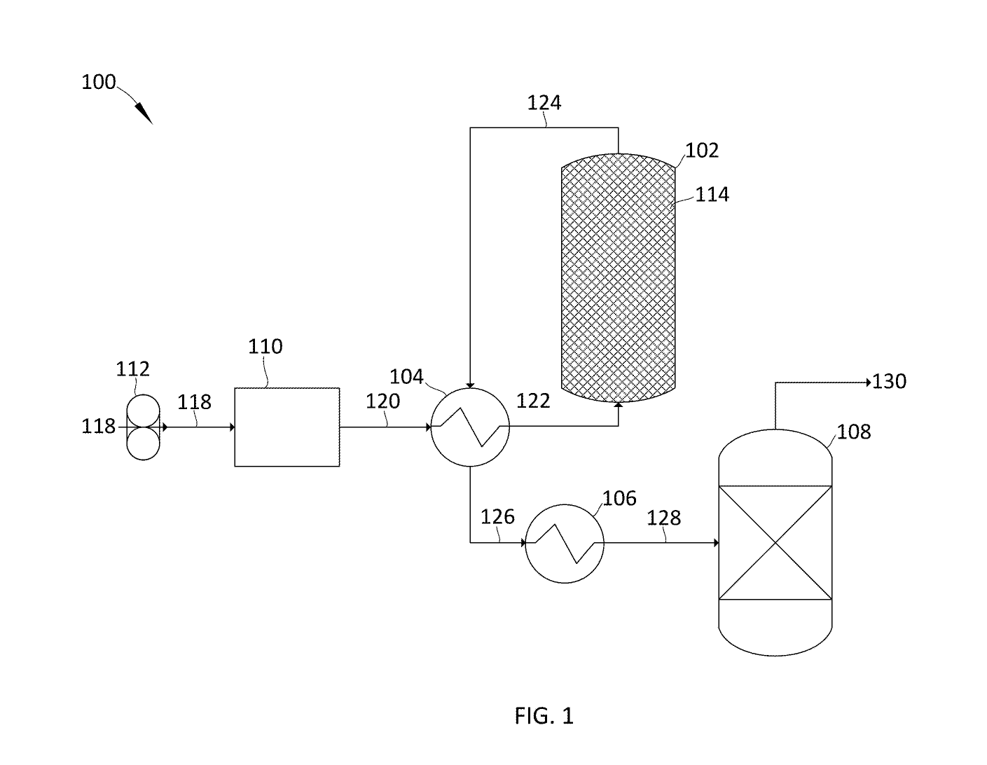

Referring now to the Figures, FIG. 1 shows an exemplary embodiment in which the described devices, systems, and methods may be implemented. In particular, FIG. 1 shows a process 100 for removing water and carbon dioxide from a flue gas as per one embodiment of the described devices, systems, and methods. A flue gas 118 is blown through blower 112 at about 0° C. and passes through a brine dryer 110. Brine dryer 110 removes more than 90% of the water from flue gas 118, resulting in a partially-dried flue gas 120 of as low as 2 ppm water at −70° C. The partially-dried flue gas 120 is passed through the heating path of a first indirect-contact heat exchanger (ICHE) 104 where it is warmed to an ambient temperature to produce a warmed, partially-dried flue gas 122. The warmed, partially-dried flue gas 122 is passed through desiccator 102 where the balance of the water is substantially stripped onto a desiccant 114, resulting in a dried flue gas 124, containing about 2 ppb water. Dried flue gas 124 passes through the cooling side of first ICHE 104 where it is cooled against the partially-dried flue gas 120 at to a temperature above that of the partially-dried flue gas 120, resulting in a first cooled-dried flue gas 126. This temperature can range from −65 to −50° C., or higher depending on losses in the exchanger. First cooled-dried flue gas 126 is cooled across a second ICHE 106, producing a second cooled-dried flue gas 128 at about −100° C. Second cooled-dried flue gas 128 is then passed through a desublimating direct-contact exchanger (DCE) 108. A portion of the carbon dioxide is stripped from the second cooled-dried flue gas 128, producing a stripped, dried-flue gas 130 at −140° C., the temperature of the desublimating DCE 108.

In another embodiment, the partially-dried flue gas 120 has about 200 ppm water at −35° C. The temperature can range between −35° C. and −70° C. in various embodiments. In other embodiments, flue gas 118 may be replaced by syngas, producer gas, natural gas, steam reforming gas, hydrocarbons, light gases, refinery off-gases, organic solvents, steam, ammonia. Each of these alternatives would require different temperatures for the second cooled-dried gas 128 and the desublimating DCE 108. The temperature of the desublimating direct-contact exchanger 108 would be at or below the temperature at which the component to be removed desublimates. The temperature of the second cooled-dried gas 128 would be above that temperature.

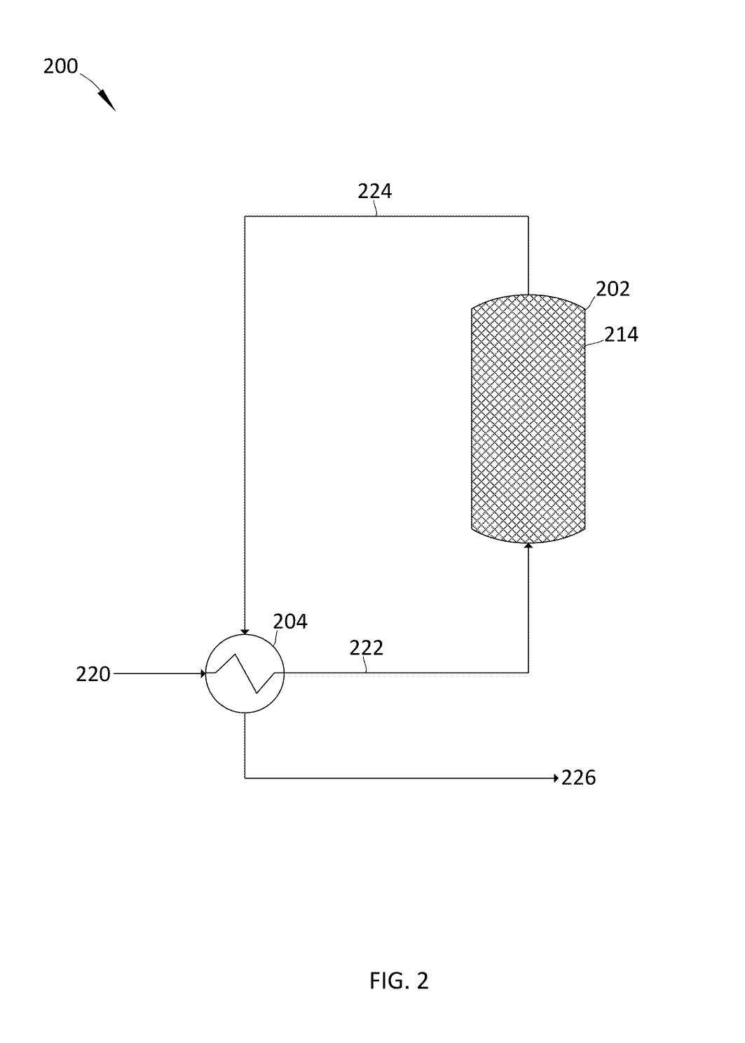

Referring to FIG. 2, FIG. 2 shows a process 200 for removing a component from a feed fluid as per one embodiment of the described devices, systems, and methods. Feed fluid 220 comprises a component and is at a first temperature. Feed fluid 220 is heated by passing through the heating path of a first ICHE 204 to produce heated feed fluid 222. Heated feed fluid 222, at a second temperature, is passed through a desiccator 202. Desiccator 202 includes a desiccant 214. The component is bound up to the desiccant 214, resulting in a stripped-heated feed fluid 224. Stripped-heated feed fluid 224 is cooled by passing through the cooling path of the first ICHE 204, cooling to a third temperature, resulting a product fluid 226. The third temperature is higher than the first temperature, due to thermodynamic losses. With an efficient exchanger, this can be reduced to near the theoretical limits for heat exchange. In this manner, desiccant 214 can be maintained at the second temperature while the feed fluid 220 is returned to a third temperature not significantly higher than the first temperature. In this manner, the feed fluid can be desiccated with a minimal temperature change.

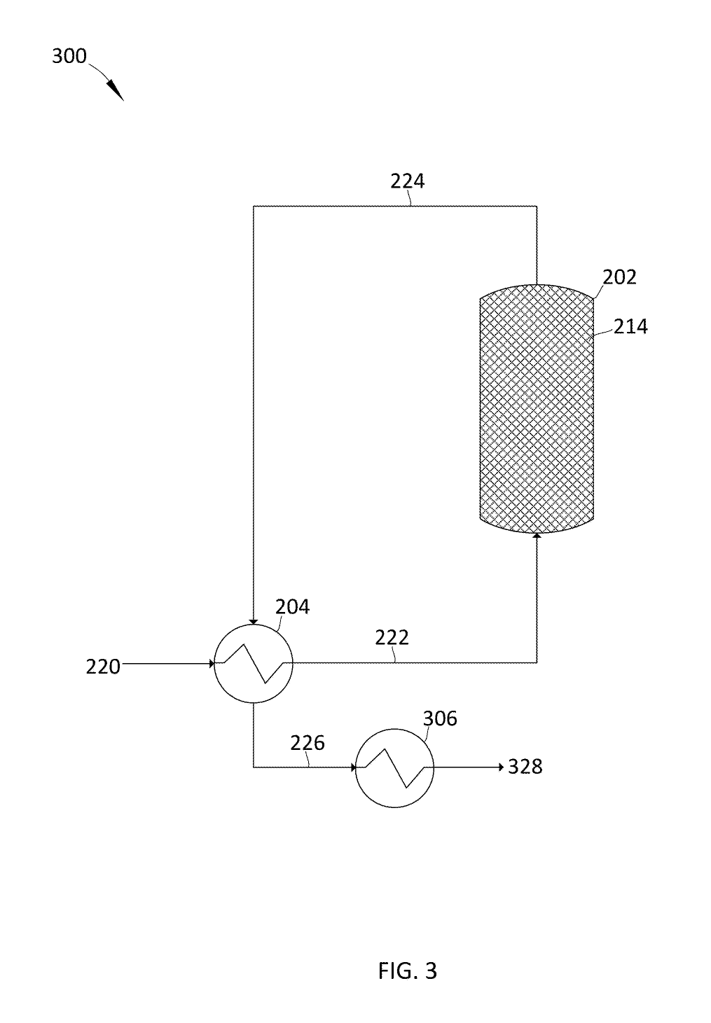

Referring to FIG. 3, FIG. 3 shows the process 300 of FIG. 2, with the addition of a second ICHE 306. While the temperature change between feed fluid 220 and product fluid 226 is minimal, there are instances where product fluid 226 needs to be further cooled before being provided to other processes (i.e., the desublimating exchanger in FIG. 1). Second ICHE 306 cools product fluid 226, producing chilled product fluid 328.

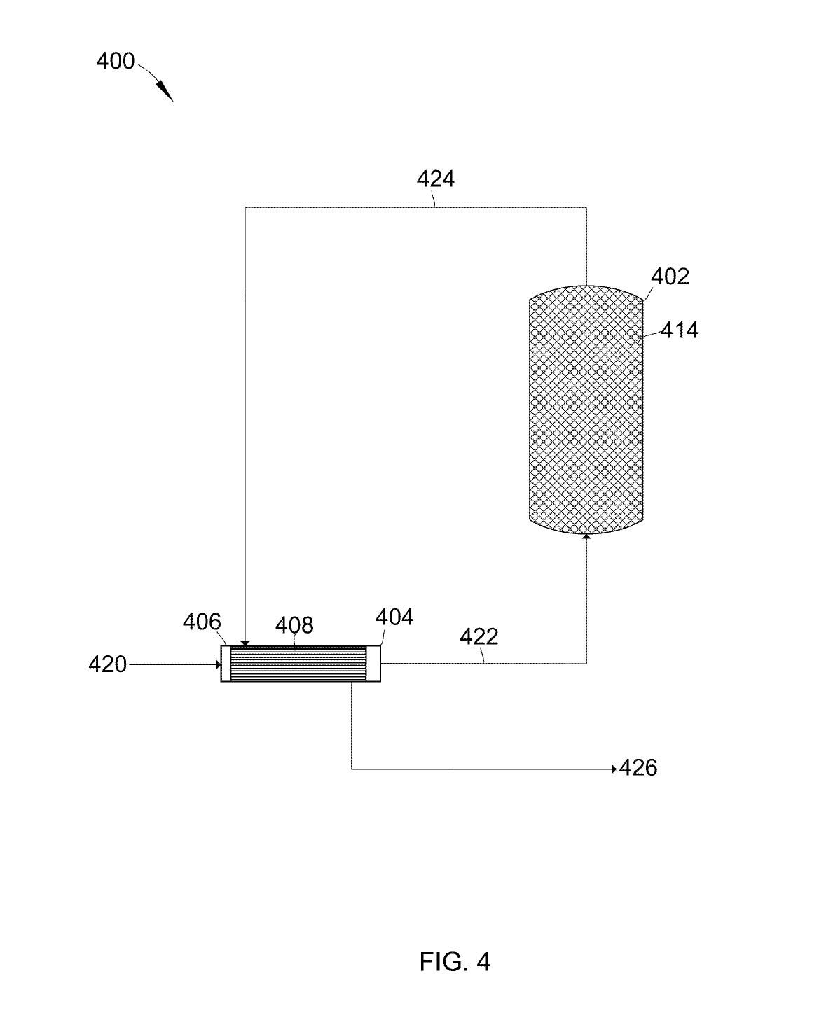

Referring to FIG. 4, FIG. 4 shows a system 400 with an ICHE and desiccator that may be used in the described devices, systems, and methods. An ICHE 404 consists of a heating path 406 and a cooling path 408. ICHE 404 is a shell and tube type heat exchanger in this example (where the heating path 406 is in the shell and the cooling path 408 is in the tubes, for example). A desiccator 402 contains desiccants 414, an input 422, and an output 424. Input 422 of the desiccator 402 is fed by the heating path 406 of the ICHE 404 and the output 424 of the desiccator 402 feeds the cooling path 408 of the ICHE 404.

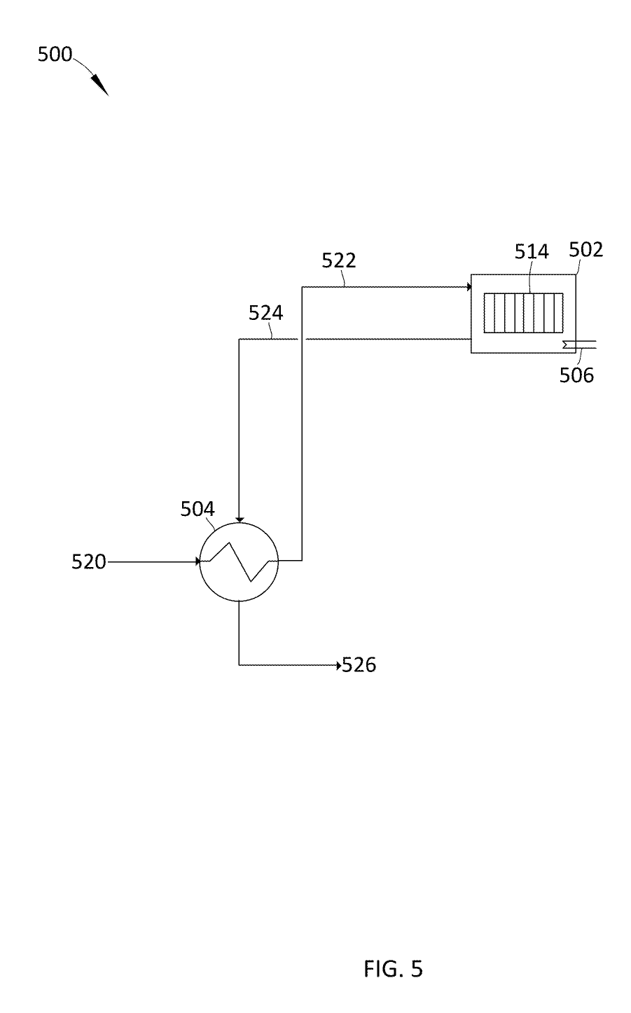

Referring to FIG. 5, FIG. 5 shows a process 500 for precipitating copper from electrolytic solution as per one embodiment of the described devices, systems, and methods. Copper deposition has been shown, in some instances, to occur faster at an elevated temperature. However, once the electrolytic solution is stripped, the heat added to the solution could be recuperated. Electrolytic solution 520 is passed through ICHE 504 where it is heated and then passed to electrowinning cell 502. Electrowinning cell 502 contains cathodes 514 upon which copper from electrolytic solution 520 is deposited, resulting in a stripped electrolytic solution 524. The electrowinning cell 502 is also heated by resistance heater 506, providing the solution with the heat that recuperation does not provide. Stripped electrolytic solution 524 then is cooled across ICHE 504, providing heat to the electrolytic solution 520, and producing cooled stripped electrolytic solution 526.

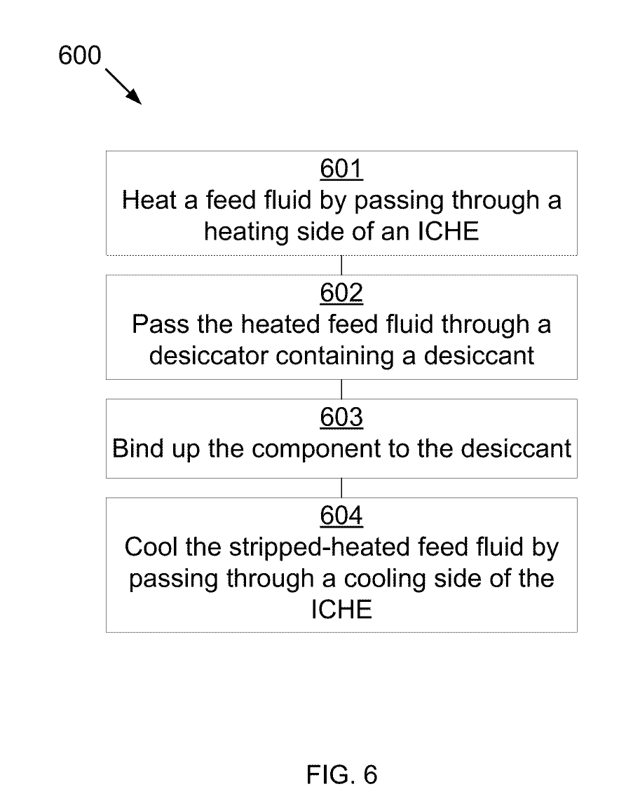

Referring to FIG. 6, FIG. 6 shows a method 600 for removing a component from a fluid. In one example, the method 600 may be implemented by a computer that controls one or more pumps, heaters, chillers, actuators, and the like. A feed fluid containing a first component is heated by passing through a heating path of an ICHE 601. The fluid is heated from a first temperature to a second temperature, resulting in a heated feed fluid. The heated feed fluid is passed through a desiccator containing a desiccant 602. The component is bound up to the desiccant, resulting in a stripped-heated feed fluid 603. The stripped-heated feed fluid is cooled by passing through a cooling path of the ICHE 604. The stripped-heated feed fluid is cooled from the second temperature to a third temperature, producing a product fluid. The third temperature is greater than the first temperature.

In some embodiments, the second temperature is maintained substantially at an ambient temperature. In one instance, the feed fluid is passed below a feed rate at which a first sensible heat transfer from the feed fluid to the desiccant is greater than a second sensible heat transfer from the ambient environment around the desiccator into the desiccant. In some instances, such as when a higher feed rate is needed than the second sensible heat transfer can accomplish, the desiccator further comprises heat exchange surfaces mounted to the desiccator that increase the second sensible heat transfer from the ambient environment around the desiccator into the desiccant. These may be fins, radiators, or other attachments that increase surface area for convection and conduction with the ambient environment.

In some embodiments, a difference between the first temperature and the third temperature is between 0° C. and 20° C. In some embodiments, the first temperature is between −80° C. and −25° C.

In some embodiments, the feed fluid may be a liquid, the liquid being water, hydrocarbons, liquid ammonia, liquid carbon dioxide, cryogenic liquids, or a combination thereof. In some embodiments, the hydrocarbons may be 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

In some embodiments, the first component comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts, precious metals, base metals, or a combination thereof.

In some embodiments, the feed fluid may be a carrier gas, the carrier gas comprising flue gas, syngas, producer gas, natural gas, steam reforming gas, hydrocarbons, light gases, refinery off-gases, organic solvents, steam, ammonia, or a combination thereof. In some embodiments, the first component may be carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts or a combination thereof.

In some embodiments, the desiccant may be activated alumina, aerogel, benzophenone, Bentonite clay, calcium chloride, calcium oxide, calcium sulfate, cobalt(ii) chloride, copper(ii) sulfate, lithium chloride, lithium bromide, magnesium sulfate, magnesium perchlorate, molecular sieve, potassium carbonate, potassium hydroxide, silica gel, sodium chlorate, sodium chloride, sodium hydroxide, sodium sulfate, sucrose, activated carbon, biochar, ion-exchange resins, diatomaceous earth, porous membranes, xeolites, conjugated microporous polymers, porous ceramics, or a combination thereof.

1. A method for removing a component from a fluid comprising:
heating a feed fluid, the feed fluid comprising a first component, by passing the feed fluid through a heating path of a first indirect-contact heat exchanger (ICHE), wherein the fluid is heated from a first temperature to a second temperature, resulting in a heated feed fluid;
passing the heated feed fluid through a desiccator, containing a desiccant, wherein the first component is bound up to the desiccant, resulting in a stripped-heated feed fluid;
cooling the stripped-heated feed fluid by passing the stripped-heated feed fluid through a cooling path of the first ICHE, wherein the stripped-heated feed fluid is cooled from the second temperature to a third temperature, the third temperature being greater than the first temperature, producing a product fluid.

2. The method of claim 1, wherein the second temperature is maintained substantially at an ambient temperature.

3. The method of claim 2, wherein passing the feed fluid at a feed rate provides a first sensible heat transfer from the desiccant to the feed fluid, and wherein the feed rate is maintained such that the first sensible heat transfer is less than or equal to a second sensible heat transfer from an ambient environment around the desiccator into the desiccant.

4. The method of claim 3, wherein the desiccator further comprises heat exchange surfaces mounted to the desiccator that increase the second sensible heat transfer from the ambient environment around the desiccator into the desiccant.

5. The method of claim 1, wherein a difference between the first temperature and the third temperature is between 0° C. and 20° C. and wherein the first temperature is between −80° C. and −25° C.

6.-11. (canceled)

12. The method of claim 1, wherein the desiccant comprises activated alumina, aerogel, benzophenone, Bentonite clay, calcium chloride, calcium oxide, calcium sulfate, cobalt(ii) chloride, copper(ii) sulfate, lithium chloride, lithium bromide, magnesium sulfate, magnesium perchlorate, molecular sieve, potassium carbonate, potassium hydroxide, silica gel, sodium chlorate, sodium chloride, sodium hydroxide, sodium sulfate, sucrose, activated carbon, biochar, ion-exchange resins, diatomaceous earth, porous membranes, xeolites, conjugated microporous polymers, porous ceramics, or a combination thereof.

13. A system for removing a component from a fluid comprising:
a first indirect-contact heat exchanger (ICHE), comprising a heating path and a cooling path;
a desiccator comprising a desiccant, the desiccator having an input and an output, wherein the input of the desiccator is fed by the heating path of the first ICHE and the output of the desiccator feeds the cooling path of the ICHE.

14. The system of claim 13, wherein an input to the heating path is below an ambient temperature, and wherein the input to the cooling path is substantially at the ambient temperature, and wherein the output of the cooling path is below the ambient temperature and warmer than the input to the heating path.

15. The system of claim 14, wherein the input to the heating path receives a feed fluid, the feed fluid comprising a first component, producing a heated feed fluid as the input of the desiccator.

16. The system of claim 15, wherein the first component is stripped from the feed fluid and bound by the desiccant.

17. The system of claim 16, wherein the desiccant is maintained substantially at ambient temperature.

18. The system of claim 17, wherein a feed rate of the feed fluid is set below a feed rate at which a first sensible heat transfer from the feed fluid to the desiccant is greater than a second sensible heat transfer from an ambient environment around the desiccator into the desiccant.

19. The system of claim 18, wherein the desiccator further comprises heat exchange surfaces mounted to the desiccator that increase the second sensible heat transfer from the ambient environment around the desiccator into the desiccant.

20. The system of claim 13, wherein the desiccant comprises activated alumina, aerogel, benzophenone, Bentonite clay, calcium chloride, calcium oxide, calcium sulfate, cobalt(ii) chloride, copper(ii) sulfate, lithium chloride, lithium bromide, magnesium sulfate, magnesium perchlorate, molecular sieve, potassium carbonate, potassium hydroxide, silica gel, sodium chlorate, sodium chloride, sodium hydroxide, sodium sulfate, sucrose, activated carbon, biochar, ion-exchange resins, diatomaceous earth, porous membranes, xeolites, conjugated microporous polymers, porous ceramics, or a combination thereof.

21. The method of claim 1, wherein the feed fluid comprises a liquid, the liquid comprising water, hydrocarbons, liquid ammonia, liquid carbon dioxide, cryogenic liquids, or a combination thereof.

22. The method of claim 7, wherein the first component comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts, precious metals, base metals, or a combination thereof.

23. The method of claim 1, wherein the feed fluid comprises a carrier gas, the carrier gas comprising flue gas, syngas, producer gas, natural gas, steam reforming gas, hydrocarbons, light gases, refinery off-gases, organic solvents, steam, ammonia, or a combination thereof.

24. The method of claim 8, wherein the first component comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, microbes, precipitated salts or a combination thereof.

25. The method of claim 9, further comprising passing a preliminary gas through a brine dryer, wherein a fraction of the preliminary gas consists of water and the brine dryer removes a portion of the water from the preliminary gas, producing the carrier gas.

26. The method of claim 9, further comprising:
cooling the product fluid to a fourth temperature by passing the product fluid through a second ICHE, producing a cooled product fluid, wherein the fourth temperature is below the first temperature; and
passing the cooled product fluid through a desublimating direct-contact heat exchanger, the desublimating direct-contact heat exchanger removing a second component from the product fluid.
